(19) United States
(12) Patent Application Publication
(10) Pub. No.: US 2026/0329071 A1
(43) Pub. Date: Oct. 22, 2026

(54) FOCUS-ADJUSTABLE HANDHELD DIGITAL MAGNIFIER

(71) Applicant: SHENZHEN MIKELONG TECHNOLOGY CO., LTD., SHENZHEN (CN)

(72) Inventors: SHANLIN WANG, SHENZHEN (CN); QUANXIN HUANG, SHENZHEN (CN)

(21) Appl. No.: 19/180,952

(22) Filed: Apr. 16, 2025

(51) Int. Cl. G02B 25/00

(52) U.S. Cl. CPC G02B 25/005

(57) ABSTRACT

Disclosed is a focus-adjustable handheld digital magnifier. By means of stationary fit between a rotatable adjusting support and an outer roller, when the adjusting support rotates, a lens holder in an inner roller will slide along threaded sliding grooves in the outer roller to adjust the focal range of a lens so as to control an axial distance between the lens and a CMOS chip. The focus-adjustable handheld digital magnifier has a simple structure, high-definition imaging within a whole focal range may be realized by accurately adjusting the axial position of the lens by means of physical structures, and images may be zoomed in and out under the condition that the definition of the images is maintained, thus improving user experience and expanding application scenarios.

### BACKGROUND OF THE INVENTION

### 1. Technical Field

The disclosure relates to the technical field of electronic magnifiers, in particular to a focus-adjustable handheld digital magnifier.

### 2. Description of Related Art

Handheld magnifiers, as basic optical tools, are widely applied to the fields of reading, precision observation, and scientific and educational entertainment. A traditional optical magnifier is typically formed by a convex lens, a support frame and a handle and forms magnified virtual images by rays refracted by the lens. However, limited by the design of a fixed focus, the traditional optical magnifier realizes clear imaging within a specified object distance range and has the problems of edge distortion, obvious aberrations and the like. With the development of the electronic technology, some handheld electronic magnifiers gradually appear on the market. The handheld electronic magnifiers acquire images by means of a camera and present magnified images by means of a display screen. Although the handheld electronic magnifiers overcome the imaging defects of optical lenses to some extent, most handheld electronic magnifiers still adopt a fixed lens structure or a digital zooming scheme and do not have a physical focusing function, making it impossible to guarantee both the definition and flexibility when details are observed closely or a whole image is captured remotely.

The core problem of existing handheld magnifiers is that the physical focus cannot be dynamically adjusted. Due to the fixed focus of the optical magnifiers, the magnifiers have to be moved frequently when used for observing objects at different distances, making operation complex and causing blurred images by an offset of the object distance. The solution of digital zooming of electronic magnifiers realizes image magnification and stretching, but this is accompanied by the sacrifice of the resolution of images, the images are made clearer not based on focal adjustment, and eye strain will be caused easily after long-term use. Therefore, a more inappropriate handheld magnifier is urgently needed to solve the technical problems mentioned above.

### BRIEF SUMMARY OF THE INVENTION

In view of the defect that handheld electronic magnifiers in the prior art cannot realize high-definition imaging by focusing, the disclosure provides a focus-adjustable handheld digital magnifier.

To fulfill the above goal, the disclosure provides a focus-adjustable handheld digital magnifier, including:
a shell, a receiving space being formed in the shell, a main control board and a display screen and a CMOS chip which are electrically connected to the main control board being arranged in the shell, and the display screen being arranged on a first surface of the shell;
a lens, the lens being arranged in the shell and protruding out of a second surface of the shell; and
a focusing assembly, the focusing assembly being movably arranged in the shell, the CMOS chip being fixedly connected to the focusing assembly, the lens being slidably connected to the focusing assembly, and an axial distance between the lens and the CMOS chip being adjusted by means of the focusing assembly.

As an improvement of the disclosure, the focusing assembly includes an adjusting support, an inner roller and an outer roller, and the adjusting support is rotatably disposed around the shell and fixedly connected to the outer roller; the inner roller is fixedly arranged on an inner wall surface of the shell, and the CMOS chip is fixedly arranged at an end, close to the second surface of the shell, of the inner roller; the outer roller is rotatably disposed around the inner roller, and the lens is slidably arranged in the inner roller and slidably connected to the outer roller; and the adjusting support rotates to drive the outer roller to rotate so as to drive the lens to be way from or close to the CMOS chip.

As an improvement of the disclosure, a lens holder is disposed around the lens, sliding through-holes are formed in a wall surface of the inner roller, threaded sliding grooves are formed in an inner wall surface of the outer roller, and sliding bumps inlaid in the threaded sliding grooves and the sliding through-holes are formed on a wall surface of the lens holder; and the sliding through-holes limit rotation of the lens holder, and the outer roller rotates to change positions of the sliding bumps by means of the threaded sliding grooves to adjust an axial position of the lens.

As an improvement of the disclosure, an insertion slot is formed in an outer wall surface of the outer roller, an insertion block is arranged on an inner wall surface of the adjusting support, and the insertion block is inlaid in the insertion slot to fixedly connect the adjusting support to the outer roller.

As an improvement of the disclosure, an adjusting block is arranged on an adjusting support.

As an improvement of the disclosure, a limiting groove is formed in the shell, and the adjusting block is arranged in the limiting groove.

As an improvement of the disclosure, a control button is arranged on the shell and electrically connected to the main control board.

As an improvement of the disclosure, one or two decorations designed based on animal ears are disposed around the shell.

As an improvement of the disclosure, a lens shade is disposed around the shell.

As an improvement of the disclosure, a battery is arranged in the shell, and a charging port is arranged on a side surface of the shell and electrically connected to the main control board.

The disclosure has the following beneficial effects: compared with the prior art, the focus-adjustable handheld digital magnifier provided by the disclosure includes the shell, the lens and the focusing assembly; the receiving space is formed in the shell, the main control board and the display screen and the CMOS chip which are electrically connected to the main control board are arranged in the shell, and the display screen is arranged on the first surface of the shell; the lens is arranged in the shell and protrudes out of the second surface of the shell; the focusing assembly is movably arranged in the shell, the CMOS chip is fixedly connected to the focusing assembly, the lens is slidably connected to the focusing assembly, and the axial distance between the lens and the CMOS chip is adjusted by means of the focusing assembly; in the disclosure, by means of stationary fit between the rotatable adjusting support and the outer roller, when the adjusting support rotates, the lens holder in the inner roller will slide along the threaded sliding grooves in the outer roller to adjust the focal range of the lens so as to control the axial distance between the lens and the CMOS chip; and the focus-adjustable handheld digital magnifier has a simple structure, high-definition imaging within a whole focal range may be realized by accurately adjusting the axial position of the lens by means of physical structures, and images may be zoomed in and out under the condition that the definition of the images is maintained, thus improving user experience and expanding application scenarios.

### BRIEF DESCRIPTION OF THE SEVERAL VIEWS OF THE DRAWINGS

FIG. 1 is a first stereogram according to the disclosure;

FIG. 2 is a second stereogram according to the disclosure;

FIG. 3 is a first exploded view according to the disclosure;

FIG. 4 is a second exploded view according to the disclosure;

FIG. 5 is a first exploded view of a focusing assembly according to the disclosure;

FIG. 6 is a second exploded view of the focusing assembly according to the disclosure.

Main reference signs:
1, shell; 11, limiting groove; 12, decoration;
2, focusing assembly; 21, adjusting support; 211, insertion block; 212, adjusting block; 22, inner roller; 221, sliding through-hole; 23, outer roller; 231, threaded sliding groove; 232, insertion slot;
3, lens; 31, lens holder; 311, sliding bump;
4, control button;
5, lens shade;
6, charging port;
7, display screen;
8, battery;
9, main control board;
10, CMOS chip.

### DETAILED DESCRIPTION OF THE INVENTION

To better clarify the disclosure, the disclosure is further described below in conjunction with accompanying drawings.

In the following description, example details are given to provide a deeper understanding of the disclosure. Obviously, the embodiments described below are merely illustrative ones, and are not all possible ones of the disclosure. It should be understood that the following specific embodiments are merely used for explaining the disclosure rather than limiting the disclosure.

It should be understood that terms “include” and/or “comprise” used here indicate the presence of a feature, entirety, step, operation, element or assembly and do not exclude the presence or addition of one or more other features, entireties, steps, operations, elements or assemblies or combinations thereof.

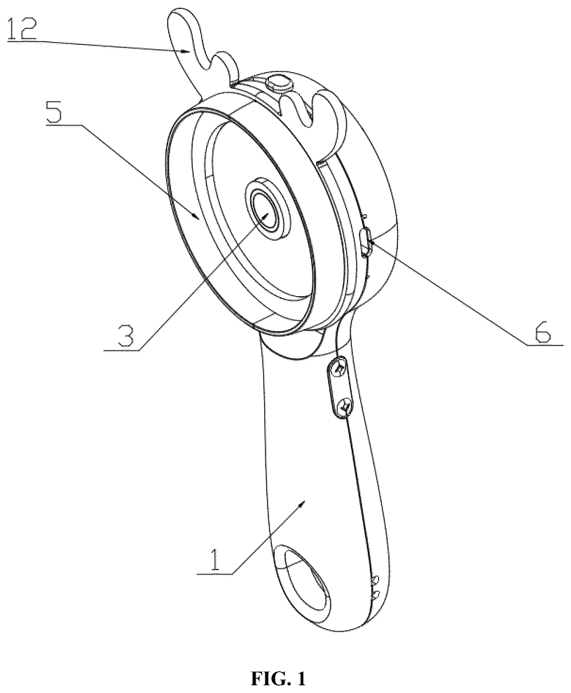

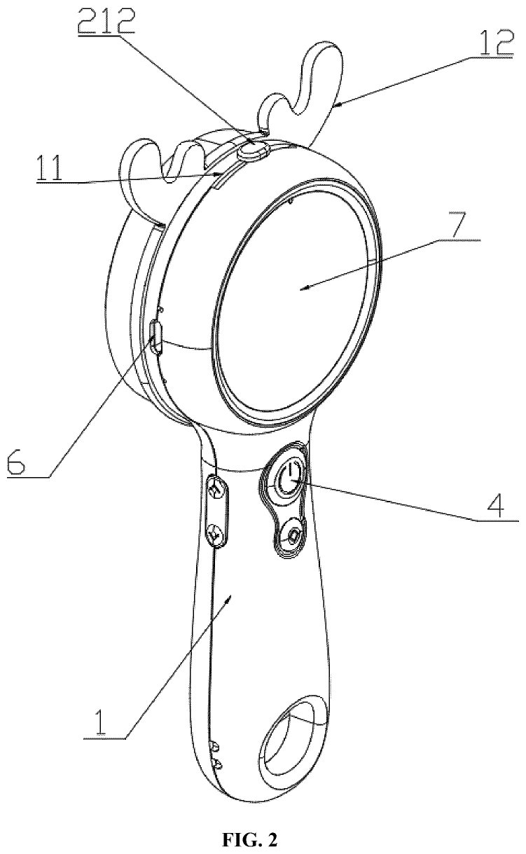

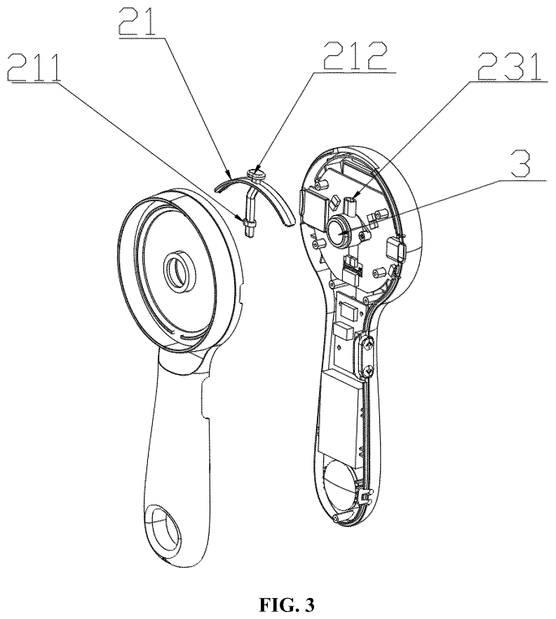

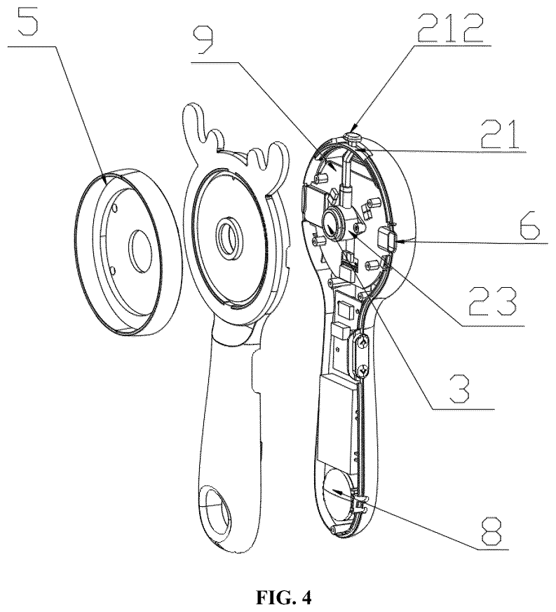

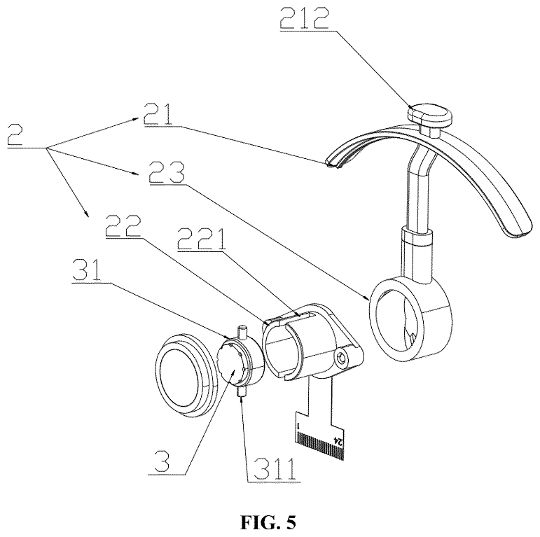

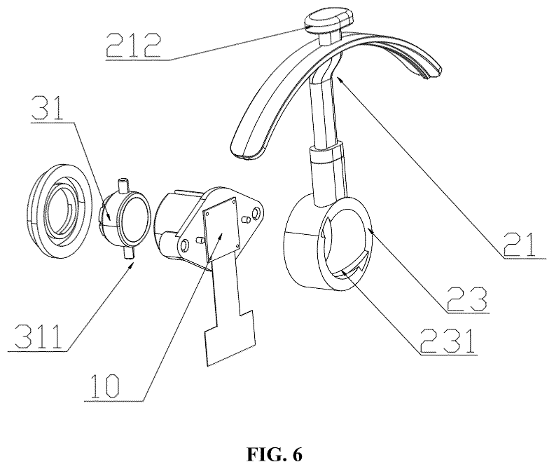

Referring to FIGS. 1-6, the disclosure provides a focus-adjustable handheld digital magnifier, including:
a shell 1, a lens 3 and a focusing assembly 2. A receiving space is formed in the shell 1, a main control board 9 and a display screen 7 and a CMOS chip 10 which are electrically connected to the main control board 9 are arranged in the shell 1, and the display screen 7 is arranged on a first surface of the shell 1. The lens 3 is arranged in the shell 1 and protrudes out of a second surface of the shell 1. The focusing assembly 2 is movably arranged in the shell 1, the CMOS chip 10 is fixedly connected to the focusing assembly 2, the lens 3 is slidably connected to the focusing assembly 2, and an axial distance between the lens 3 and the CMOS chip 10 is adjusted by means of the focusing assembly 2. In the disclosure, the axial distance between the lens 3 and the CMOS chip 10 is adjusted by means of the focusing assembly 2, and the lens 3 is in sliding fit with the focusing assembly 2, such that the lens 3 may be away from or close to the CMOS chip 10 to adjust the focal range; and by adjusting the focal range by means of the focusing assembly 2, clear images are formed in the display screen 7 by means of the CMOS chip 10, and the images may be zoomed in and out under the condition that the definition of the images is maintained. The focus-adjustable handheld digital magnifier is simple in structure and allows for manual focusing by means of the cooperation between simple mechanical structures.

In this embodiment, the focusing assembly 2 includes an adjusting support 21, an inner roller 22 and an outer roller 23. The adjusting support 21 is rotatably disposed around the shell 1 and fixedly connected to the outer roller 23. The inner roller 22 is fixedly arranged on an inner wall surface of the shell 1, and the CMOS chip 10 is fixedly arranged at an end, close to the second surface of the shell 1, of the inner roller 22. The outer roller 23 is rotatably disposed around the inner roller 22, and the lens 3 is slidably arranged in the inner roller 22 and slidably connected to the outer roller 23. The adjusting support 21 rotates to drive the outer roller 23 to rotate so as to drive the lens 3 to be away from or close to the CMOS chip 10. Because the lens 3 is slidably arranged in the inner roller 22 and the outer roller 23 is rotatable with respect to the inner roller 22 and in sliding fit with the lens 3, when the adjusting support 21 drives the outer roller 23 to rotate, a lens holder 31 in sliding fit with the outer roller 23 will be driven, thus changing the axial position of the lens 3; and because the CMOS chip 10 is fixedly arranged in the inner roller 22, the focal range may be adjusted by increasing or decreasing the axial distance between the lens 3 and the CMOS chip 10.

In this embodiment, the lens holder 31 is disposed around the lens 3, sliding through-holes 221 are formed in a wall surface of the inner roller 22, threaded sliding grooves 231 are formed in an inner wall surface of the outer roller 23, and sliding bumps 311 inlaid in the threaded sliding grooves 231 and the sliding through-holes 221 are formed on a wall surface of the lens holder 31. The sliding through-holes 221 limit rotation of the lens holder 31, the outer roller 23 rotates to change the positions of the sliding bumps 311 by means of the threaded sliding grooves 231 so as to adjust the axial position of the lens 3. Because the sliding bumps 311 on the lens holder 31 are slidable in the threaded sliding grooves 231, when the adjusting support 21 controls the outer roller 23 to rotate, the sliding bumps 311 slide along paths defined by the threaded sliding grooves 231 and the sliding through-holes 221; because the inner roller 22 is fixedly connected to the wall surface of the shell 1, the inner roller 22 will not rotate, and the sliding through-holes 221 mainly limit the rotation of the lens holder 31; then, the sliding bumps 311 move back and forth along the paths defined by the threaded sliding grooves 231 to adjust the axial position of the lens holder 31, and the axial position of the lens 3 is changed synchronously. Therefore, by rotation of the adjusting support 21, the lens 3 may be controlled to be close to or away from the CMOS chip 10 to satisfy the requirements for different focal ranges of users.

In this embodiment, an insertion slot 232 is formed in an outer wall surface of the outer roller 23, an insertion block 211 is arranged on an inner wall surface of the adjusting support 21, and the insertion block 211 is inlaid in the insertion slot 232 to fixedly connect the adjusting support 21 to the outer roller 23. Wherein, the adjusting support 21 is fixedly connected to the outer roller 23 by inlaying the insertion block 211 in the insertion slot 232; and when the adjusting support 21 rotates, the outer roller 23 is driven to rotate by means of the cooperation between the insertion block 211 and the insertion slot 232.

In this embodiment, a control button 4 is arranged on the shell 1 and electrically connected to the main control board 9. On-off of the focusing assembly 2 and the display screen 7 and the magnification of the focusing assembly 2 are controlled by means of the control button 4.

In this embodiment, an adjusting block 212 is arranged on the adjusting support 21, and the adjusting support 21 may be rotated by users more easily by means of the adjusting block 212, thus improving the practicability of the product. Further, a limiting groove 11 is formed in the shell 1, and the adjusting block 212 is arranged in the limiting groove 11. The limiting groove 11 is arranged to limit the movement of the adjusting block 212, such that the amplitude of rotation of the adjusting support 21 is prevented from exceeding the stroke length of the threaded sliding grooves 231.

In this embodiment, one or two decorations 12 designed based on animal ears are disposed around the shell 1. The decorations 12 improve the overall interestingness of the product, thus making the product more attractive and lovely.

In this embodiment, a lens shade 5 is disposed around the shell 1. By arranging the lens shade 5 on an observation surface of the shell 1, a better field of view and better brightness are provided for the lens 3 and the CMOS chip 10, and reflection of overbright rays is avoided, thus preventing burrs and overexposure of images formed in the display screen 7 by the focusing assembly 2.

In this embodiment, a battery 8 is arranged in the shell 1, and a charging port 6 is formed in a side surface of the shell 1 and electrically connected to the battery 8 and the main control board 9. The battery 8 supplies power to the main control board 9, the focusing assembly 2 and the display screen 7 to guarantee normal operation, and the battery 8 is charged by means of the charging port 6 to guarantee later use.

The operating principle of the disclosure is as follows:

In use, the adjusting block on the shell is slid to allow the adjusting support to drive the outer roller to rotate; and because the sliding bumps are arranged at two ends of the lens holder and sequentially arranged in the sliding through-holes in the inner roller and the threaded sliding grooves in the inner wall surface of the outer roller and the outer roller is rotatably disposed around the inner roller, when the outer roller rotates, the sliding bumps will slide in the threaded sliding grooves and the sliding through-holes to change the axial position of the lens and the axial position of the lens holder, thus adjusting the focal range of the lens by means of physical structures.

The disclosure has the following advantages:

1) In the disclosure, by means of the cooperation between the focusing assembly and the lens holder, the adjusting support may drive the outer roller to rotate to allow the lens holder to move axially in the outer roller so as to adjust the axial distance between the lens and the CMOS chip, thus adjusting the focal range of the lens of the product.

2) The decorations designed based on animal ears are disposed around the shell, thus improving the overall aesthetics and interestingness of the product.

The embodiments disposed above are merely several specific ones of the disclosure, and the disclosure is not limited to the above embodiments. All variations that may be obtained by any skilled in the art should fall within the protection scope of the disclosure.

What is claimed is:

1. A focus-adjustable handheld digital magnifier, comprising:
a shell, a receiving space being formed in the shell, a main control board and a display screen and a CMOS chip which are electrically connected to the main control board being arranged in the shell, and the display screen being arranged on a first surface of the shell;
a lens, the lens being arranged in the shell and protruding out of a second surface of the shell; and
a focusing assembly, the focusing assembly being movably arranged in the shell, the CMOS chip being fixedly connected to the focusing assembly, the lens being slidably connected to the focusing assembly, and an axial distance between the lens and the CMOS chip being adjusted by means of the focusing assembly.

2. The focus-adjustable handheld digital magnifier according to claim 1, wherein the focusing assembly comprises an adjusting support, an inner roller and an outer roller, and the adjusting support is rotatably disposed around the shell and fixedly connected to the outer roller; the inner roller is fixedly arranged on an inner wall surface of the shell, and the CMOS chip is fixedly arranged at an end, close to the second surface of the shell, of the inner roller; the outer roller is rotatably disposed around the inner roller, and the lens is slidably arranged in the inner roller and slidably connected to the outer roller; and the adjusting support rotates to drive the outer roller to rotate so as to drive the lens to be way from or close to the CMOS chip.

3. The focus-adjustable handheld digital magnifier according to claim 2, wherein a lens holder is disposed around the lens, sliding through-holes are formed in a wall surface of the inner roller, threaded sliding grooves are formed in an inner wall surface of the outer roller, and sliding bumps inlaid in the threaded sliding grooves and the sliding through-holes are formed on a wall surface of the lens holder; and the sliding through-holes limit rotation of the lens holder, and the outer roller rotates to change positions of the sliding bumps by means of the threaded sliding grooves to adjust an axial position of the lens.

4. The focus-adjustable handheld digital magnifier according to claim 2, wherein an insertion slot is formed in an outer wall surface of the outer roller, an insertion block is arranged on an inner wall surface of the adjusting support, and the insertion block is inlaid in the insertion slot to fixedly connect the adjusting support to the outer roller.

5. The focus-adjustable handheld digital magnifier according to claim 1, wherein a control button is arranged on the shell and electrically connected to the main control board.

6. The focus-adjustable handheld digital magnifier according to claim 1, wherein an adjusting block is arranged on an adjusting support.

7. The focus-adjustable handheld digital magnifier according to claim 6, wherein a limiting groove is formed in the shell, and the adjusting block is arranged in the limiting groove.

8. The focus-adjustable handheld digital magnifier according to claim 1, wherein one or two decorations designed based on animal ears are disposed around the shell.

9. The focus-adjustable handheld digital magnifier according to claim 1, wherein a lens shade is disposed around the shell.

10. The focus-adjustable handheld digital magnifier according to claim 1, wherein a battery is arranged in the shell, and a charging port is arranged on a side surface of the shell and electrically connected to the main control board.
